(19) United States
(12) Patent Application Publication
(10) Pub. No.: US 2017/0277955 A1
(43) Pub. Date: Sep. 28, 2017

(54) VIDEO IDENTIFICATION METHOD AND SYSTEM

(71) Applicants: LE HOLDINGS (BEIJING) CO., LTD., Beijing (CN); LECLOUD COMPUTING CO., LTD, Beijing (CN)

(72) Inventors: Yang LIU, Beijing (CN); Maosheng BAI, Beijing (CN); Wei WEI, Beijing (CN); Xingyu LI, Beijing (CN)

(21) Appl. No.: 15/246,166

(22) Filed: Aug. 24, 2016

Related U.S. Application Data
(63) Continuation of application No. PCT/CN2016/088889, filed on Jul. 6, 2016.

(30) Foreign Application Priority Data
Mar. 23, 2016 (CN) 201610168258.1

(51) Int. Cl. G06K 9/00; G06N 3/08; G06N 3/04; G06K 9/46; G06K 9/62

(52) U.S. Cl. CPC G06K 9/00718; G06K 9/00744; G06K 9/4628; G06K 9/6298; G06N 3/04; G06N 3/08

(57) ABSTRACT

The disclosure provides a video identification method, system and non-transitory computer-readable medium. The method includes: preprocessing a plurality of images of known types where the preprocessing at least includes data augmentation, inputting the plurality of preprocessed images into a convolutional neural network to perform type identification training by use of an identification model, and optimizing the identification model based on a type identification result and the known types, acquiring multiple images to be identified, and identifying the multiple images to be identified by use of the optimized identification model in the convolutional neural network.

### CROSS REFERENCE TO RELATED APPLICATIONS

This application is a continuation of International Application No. PCT/CN2016/088889, filed on Jul. 6, 2016, which is based upon and claims priority to Chinese Patent Application No. 201610168258.1, filed on Mar. 23, 2016, the entire contents of both of which are incorporated herein by reference.

### TECHNICAL FIELD

Embodiments of the present disclosure relate to the technical field of information security, and more particularly to a video identification method and system.

### BACKGROUND

With rapid development of computer hardware and internet-based big data-related technologies, the number of videos in the internet is increasing explosively. However, there are lots of redundant and duplicate video contents as well as some illegal video contents involved in IPR (Intellectual Property Rights) infringement, bloodiness, violence, terrorism, obscenity and the like.

At present, people can use computers to complete some visual recognition tasks. For example, people can utilize a computer monitoring system to complete smart surveillance, and can use computers to complete recognition, examination and the like for video contents. Generally, when people use the computers to complete recognition and examination for videos, they have to create complex calculation models to compute large quantities of data. During the implementation of the present disclosure, the inventor finds that if a created calculation model is poor in performance and there is error accumulation in computations, it will cause computer identification errors or slow down the computer identification speed. Consequently, people's requirements on accuracy and timeliness cannot be met.

### SUMMARY

The embodiments of the present disclosure provide a video identification method, electronic device and non-transitory computer-readable medium.

The present disclosure provides a video identification method. The method may include: preprocessing a plurality of images of known types, wherein the preprocessing at least includes data augmentation, inputting the plurality of preprocessed images into a convolutional neural network to perform type identification training by use of an identification model, and optimizing the identification model based on a type identification result and the known types, acquiring multiple images to be identified; and identifying the multiple images to be identified by use of the optimized identification model in the convolutional neural network.

The present disclosure provides an electronic device for video identification. The electronic device may include: at least one processor, and a memory communicably connected with the at least one processor for storing instructions executable by the at least one processor, where execution of the instructions by the at least one processor causes the at least one processor to: preprocess a plurality of images of known types, wherein the preprocessing at least comprises data augmentation, input the preprocessed images into a convolutional neural network to perform type identification training by use of an identification model, and optimize the identification model based on a type identification result and the known types, acquire multiple images to be identified, and identify the multiple images to be identified by use of the optimized identification model in the convolutional neural network.

The present disclosure also provides a non-transitory computer-readable storage medium storing executable instructions for a video identification. The executable instructions, when executed by a processor, may cause the processor to: preprocess a plurality of images of known types to at least include data augmentation, input the plurality of preprocessed images into a convolutional neural network to perform type identification training by use of an identification model, and optimize the identification model based on a type identification result and the known types, acquire multiple images to be identified, and identify the multiple images to be identified by use of the optimized identification model in the convolutional neural network.

It should be understood that both the foregoing general description and the following detailed description are exemplary and explanatory only and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the embodiments of the present disclosure, figures to be used in the embodiments will be briefly introduced in the following. Apparently, figures in the following description are some embodiments of the present disclosure, and other figures can be obtained by those skilled in the art based on these figures without inventive efforts.

FIG. 1 shows a flow chart of a video identification method according to an embodiment of the present disclosure;

FIG. 2 shows a flow chart of acquiring multiple images to be identified according to an embodiment of the present disclosure;

FIG. 3(a) shows a schematic structural drawing of a process in which an image is rotated by 45 degrees, cropped and zoomed during data augmentation according to an embodiment of the present disclosure;

FIG. 3(b) shows a schematic structural drawing of a process in which an image is augmented to eight images according to an embodiment of the present disclosure;

FIG. 4 shows a flow chart of generating an image with low luminance according to an embodiment of the present disclosure;

FIG. 5 shows a flow chart of acquiring multiple images to be identified according to an embodiment of the present disclosure;

FIG. 6 shows a schematic structural drawing of a video identification system according to an embodiment of the present disclosure;

FIG. 7 shows a structural drawing of a to-be-identified image generating unit according to an embodiment of the present disclosure; and

FIG. 8 shows a schematic drawing of user equipment according the embodiments of the present application.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

The embodiments of the present disclosure may provide a video identification method, system and non-transitory computer-readable medium to solve the problems of low recognition accuracy as well as poor fault tolerance ability and generalization ability.

Since the convolutional neural network has its own learning feature, with the enhancement of its generalization ability, the accuracy of using deep neural networks to recognize and classify targets will also be improved continually. Therefore, the present disclosure may use the convolutional neural network as a main recognition tool, and by the augmented image identification training, the generalization ability of the model in the convolutional neural network can be improved. Compared with a conventional complex calculation and recognition model, the convolutional neural network and the model thereof are simpler and more efficient. Moreover, the video identification accuracy is improved, and the video identification speed is accelerated by using the optimized convolutional neural network for video identification.

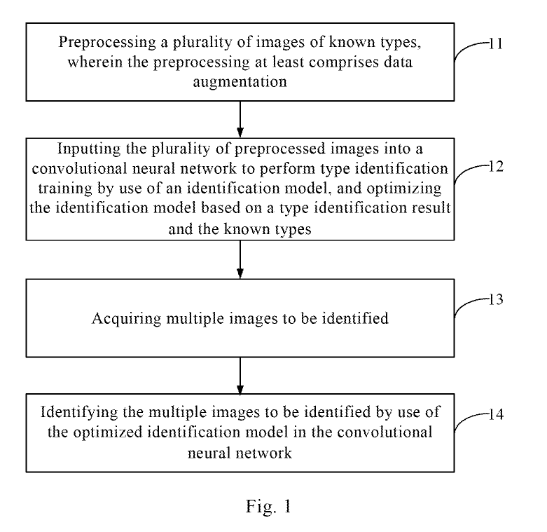

As shown in FIG. 1, the video identification method includes the following steps:

step 11: preprocessing by a video identification device a plurality of images of known types, wherein the preprocessing at least includes data augmentation;

step 12: inputting by the video identification device the plurality of preprocessed images into a convolutional neural network to perform type identification training by use of an identification model, and optimizing by the video identification device the identification model based on a type identification result and the known types;

step 13: acquiring by the video identification device multiple images to be identified, wherein the number of images to be identified may be determined as one or more according to the actual situations; and

step 14: identifying by the video identification device the multiple images to be identified by use of the optimized identification model in the convolutional neural network.

The method according to the present embodiment can be configured to identify redundant and duplicate video contents as well as illegal video contents involved in IPR (Intellectual Property Rights) infringement, bloodiness, violence, terrorism, obscenity and the like.

Since the convolutional neural network has its own learning feature, with the enhancement of its generalization ability, the accuracy of using deep neural networks to recognize and classify targets will also be improved continually. Therefore, the present disclosure may use the convolutional neural network as a main recognition tool, and by the augmented image identification training, the generalization ability of the model in the convolutional neural network can be improved. Compared with a conventional complex calculation and recognition model, the convolutional neural network and the model thereof are simpler and more efficient. Moreover, the video identification accuracy is improved, and the video identification speed is accelerated by using the optimized convolutional neural network for video identification.

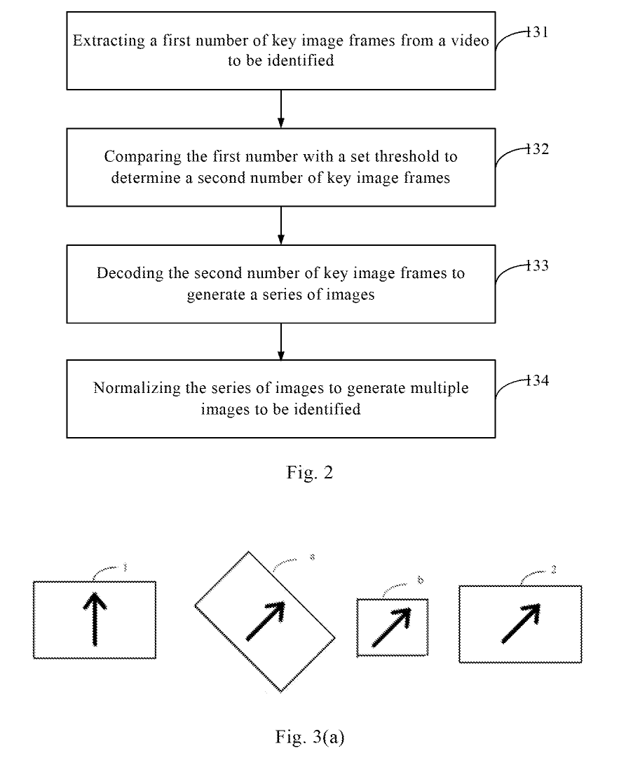

As shown in FIG. 2, said acquiring the multiple images to be identified (namely, step 13 shown in FIG. 1) may include:

step 131: extracting by a video identification device a first number of key image frames from a video to be identified;

step 132: comparing by the video identification device the first number (e.g., X1) with a set threshold (e.g., Y) to determine a second number (e.g., X2) of key image frames;

step 133: decoding by the video identification device the second number of key image frames to generate a series of images; and

step 134: normalizing by the video identification device the series of images to generate the multiple images to be identified.

According to the present embodiment, in order to enable the convolutional neural network to deal with a video identification task, before decoding and identifying video image frames meeting the conditions, a certain number of key image frames are extracted from a video and a threshold is set for the number of the key image frames. Thus, while ensuring the quality of the image frames (key frames), the number of the image frames can be decreased, the data computation load is reduced, the data computation time is shortened, and the processor computation load is reduced, so that equipment with lower hardware configuration cost is able to undertake the video identification task.

In some embodiments, the video identification method may include:

step 11′: acquiring by a video identification device multiple images to be identified;

step 12′: inputting by the video identification device the plurality of preprocessed images into a convolutional neural network in batches to perform identification by use of an identification model, and updating by the video identification device the identification model based on an identification result; and

step 13′: performing by the video identification device identification to the next round of videos by use of the updated identification model.

In some embodiments, said acquiring the multiple images to be identified (namely, step 11′) may include:

step 111′: extracting by a video identification device a first number of key image frames from a video to be identified;

step 112′: comparing by the video identification device the first number with a set threshold to determine a second number of key image frames;

step 113′: decoding by the video identification device the second number of key image frames to generate a series of images; and

step 114′: preprocessing by the video identification device the series of images, wherein the preprocessing may include data augmentation and image mean reduction image by image.

Therefore, in the present embodiment, the identification model can continuously learn and be updated automatically, so as to further improve the followed identification accuracy.

For improving the generalization ability of the identification model in the convolutional neural network, the identification model can be trained so as to improve the image recognition accuracy. In the present embodiment, effective data augmentation on each image may be carried out. For example, data augmentation includes rotation, random cropping, scaling or color jitter. In addition, via lots of experiments, the applicant finds that in equal-angle rotation, the generalization ability and the accuracy of the identification model are higher compared with flipping in the horizontal and vertical directions.

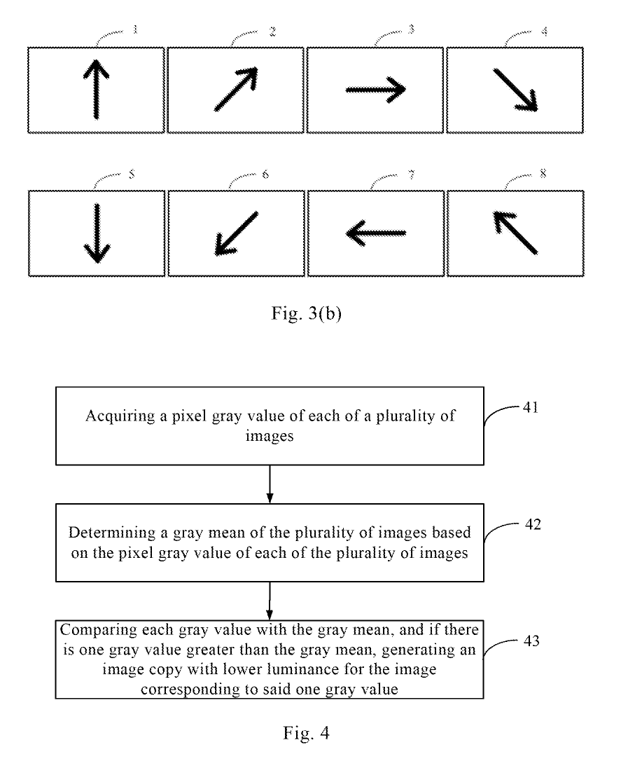

In order to vividly reflect the image direction, in FIGS. 3(a) and 3(b), an image 1 in which the arrow is vertically upward is taken as an example to describe in detail a data augmentation implementation manner for the image.

As shown in FIG. 3(a), firstly, the image 1 whose size is matched with that of a display screen is rotated clockwise by 45 degrees to obtain an image a. Obviously, the size of the image a is unmatched with that of the display screen. So, in order to match the size of the image with that of the display screen and ensure the information integrity to the greatest extent, in the present embodiment, an image b can be cropped from the image a, and then, the image b is zoomed as an image 2.

Therefore, in the present embodiment, by rotation, cropping and zoom, the image 1 can be augmented to the image 2, and moreover, effective information (which is usually in the middle, for example, the vertically upward arrow) can be effectively stored.

Similarly, as shown in FIG. 3(b), the image 2 can be rotated clockwise by 45 degrees, and then the rotated image 2 is cropped and zoomed to obtain an image 3. Of course, the image 1 can be directly augmented to the image 3 by clockwise 90-degree rotation, cropping and zoom in sequence.

In the present embodiment, equal-angle rotation, cropping and scaling may be used. An original key image (the image 1) may be rotated counter-clockwise or clockwise by 45 degrees every time. After the image is rotated by 360 degrees, namely, a round, images 2, 3, 4, 5, 6, 7 and 8 are obtained respectively. Here, eight images are obtained based on the original key image, so that the image data volume is greatly increased, thereby enhancing the generalization ability of the model and improving the accuracy of the training model in the convolutional neural network.

In the present embodiment, the model in the convolutional neural network is trained to enhance its generalization ability and robustness. By using the trained model to recognize images in batches, the video identification accuracy can be improved, and moreover, the video identification speed is accelerated.

In the present embodiment, the model in the convolutional neural network can be trained in a data augmentation manner (which may be completed before training). The data augmentation manner may include equal-angle rotation, cropping, scaling and the like.

To further improve the generalization ability of the training model in the convolutional neural network, the augmented data volume may be increased by reducing a rotation angle. For example, an angle can be adjusted from 45 degrees to 10 degrees, so an original image which only could be augmented to 8 images is augmented to 36 images now. Thus, although the data volume is increased, the generalization ability of the training model in the convolutional neural network is improved and the followed image recognition accuracy is improved accordingly, the training time becomes longer as the data computation is increased.

Likewise, the augmented data volume can be reduced by increasing a rotation angle. For example, an angle can be adjusted from 45 degrees to 90 degrees, so an original image which could be augmented to 8 images is only augmented to 4 images now. Thus, although the training speed is accelerated, the followed image recognition accuracy is affected as the generalization ability of the training model in the convolutional neural network is influenced negatively.

Therefore, a great deal of experimental data show that when the rotation angle is 45 degrees, the training time and the video identification accuracy may achieve a relatively balanced optimization effect.

FIG. 4 shows a flow chart of generating an image with low luminance according to an embodiment of the present disclosure. Data augmentation may also include image luminance processing. In the present embodiment, for meeting the requirement of identifying whether a video contains pornographic contents, some sample images with lower luminance (because pornographic videos are made generally in a dark environment, so the image luminance is lower) are artificially added into a training sample (namely, an image of known type, such as a pornographic picture for the pornographic contents). The sample images with lower luminance are generated by reducing the luminance of a copy of an existing sample image. As shown in FIG. 4, the image luminance processing includes the follows steps.

Step 41: a video identification device acquires a pixel gray value, ga (i), of each of a plurality of images, wherein i can be 1, 2, 3, . . . and n.

For instance, 80 images can be generated after 10 images are subjected to 45 degrees equal-angle rotation, and then gray values, ga (1), ga (2) . . . and ga (80) of the images 1-80 are counted.

Step 42: the video identification device determines a gray mean of a plurality of images based on the pixel gray value of each of the plurality of images.

Step 43: the video identification device compares each gray value with the gray mean, and if there is one gray value greater than the gray mean, the video identification device generates an image copy with lower luminance for the image corresponding to said one gray value.

Specifically, the formula for determining a gray mean of all images (such as 80 images) may be as follows:

$$ga = \frac{1}{n} {\sum }_{i = 0}^{n - 1} 0.299 * {R}_{i} + 0.587 * {G}_{i} + 0.114 * {B}_{i}$$

Wherein n states the total number of sample images; Ri, Gi and Bi, which respectively represent component values of r, g and b of a current sample image, form a two-dimensional matrix; and the sizes of the Ri, Gi and Bi correspond to the length and width of the current image respectively. Each element of the matrix is required to be processed, namely, processing each pixel of the current image.

In the present embodiment, an image transformation formula is embodied as follows:

$$\{ \begin{matrix}{R}_{i} = 255 * {( \frac{{R}_{i }}{255} )}^{2} \\ {G}_{i} = 255 * {( \frac{{G}_{i}}{255} )}^{2} \\ {B}_{i} = 255 * {( \frac{{B}_{i}}{255} )}^{2}\end{matrix}$$

After the above processing, the number of image samples with low luminance corresponding to image samples with higher luminance can be increased, so that on the one hand, the total number of samples is increased, and on the other hand, the generalization ability and the robustness of a final model in the convolutional neural network are improved, thereby improving the followed video identification accuracy.

Of course, in the above method, gray means can also be determined based on pixel gray values of all images, then the gray means of all the images are counted to calculate the gray mean of each image, so as to achieve the purpose of the present disclosure. But, through such a manner, the computation time is relatively longer compared with the above processing.

In some embodiments, preprocessing further including: image mean reduction image by image (for example, values of R, G and B of each image are reduced) or further processing each image by using a color jitter method. Through preprocessing, data processing and handling (which may be normalized data processing) is facilitated, so that the video identification speed is accelerated.

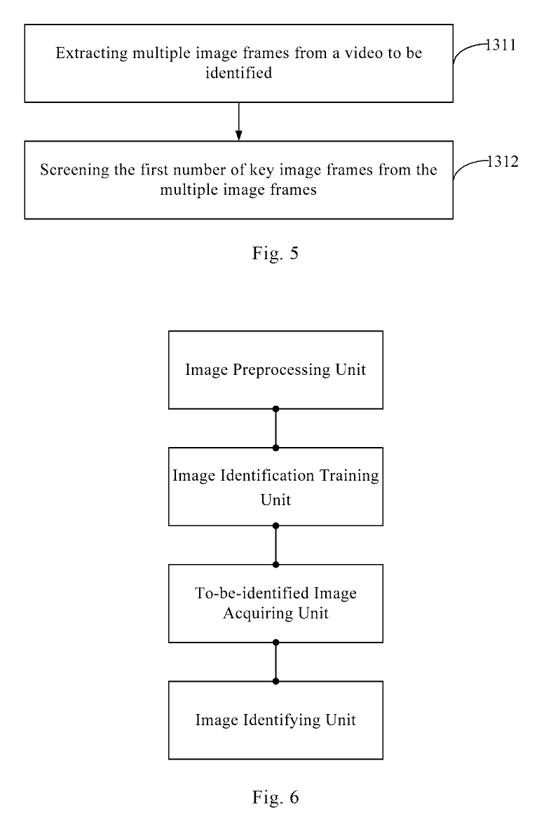

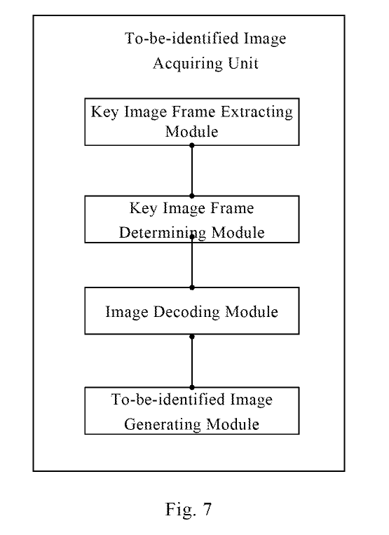

As shown in FIG. 5, the step (namely, step 131 shown in FIG. 2) of extracting a first number of key image frames from a video to be identified may include the following sub-steps:

sub-step 1311: extracting by a video identification device multiple image frames from a video to be identified; and

sub-step 1312: screening by the video identification device a first number of key image frames from the multiple image frames.

The video in the present embodiment is composed of a series of image frames. If a video frame rate is 25 fps, it means there are 25 images per second. If the video is very long, it indicates that the number of image frames in the video is very great. In the present embodiment, the first number of key image frames (containing information of a complete and clear image) are screened out from multiple image frames in the video to be identified, so that not only can the screened out key image frames be well suitable for a detection task, but also the detection accuracy is improved, the detection time is shortened, and moreover, the followed image identification processing is facilitated.

Specifically, in some embodiments, in order to control the number of key frames to prevent the detection speed from being affected by excessive key frames in some all I-frame (which are intra-coded frames in MPEG coding and represent a complete picture) videos, the maximum number of key frames is limited. For improving the video identification accuracy and shortening the identification time, the embodiments of the present disclosure refer to a large number of experimental data (e.g., identification speed and identification time), and preferably, the threshold Y is 5,000.

Specifically, in the present embodiment, if X1 is 1000 less than or equal to Y, it indicates that X1 is in the threshold range, and then X2 is also given as 1,000. In this point, 100 key image frames extracted from a video to be identified are decoded.

If X1 is 20,000, greater than Y, it indicates that X1 is not in the threshold range, which will affect the video approval speed. Therefore, it is determined that X2 is one N-th of X1 to enable the second number to be less than or equal to the threshold, wherein N is an integer greater than or equal to 2. Particularly, the value of N can be customized according to the requirement on computation accuracy or time. For instance, if N is 10, it shows that only 2,000 image frames in 20,000 key image frames from the video to be identified are required to be decoded.

Thus, in the present embodiment, the number of key frames required to be decoded is controlled by setting the threshold to avoid the problem that the identification speed slows down owing to the increase of the sample quantity, while extracting samples (key frames) as much as possible. Certainly, if the hardware configuration and the computation speed of a processor are higher, the threshold can be set large enough to improve the video identification accuracy.

In some embodiments, the normalizing may include performing image mean reduction image by image to a series of images.

In some embodiments, the video detection speed can be accelerated by caching the decoded images and then parallelly detecting the images in batches.

Specifically, during the batch detection, firstly, a certain number (batch_size) of key frames are extracted, and then the key frames are transmitted into a model in the convolutional neural network to be detected. While detection is performed, the next batch of key frames are prepared in a multi-threaded parallel manner, so time can be greatly saved. In addition, when the number of the last batch of key frames is inadequate (that is, the number of the last batch of key frames is less than the batch_size), the insufficient part may be filled with pure black images.

As shown in FIG. 6, a video identification system may include: an image preprocessing unit, an image identification training unit, a to-be-identified image acquiring unit and an image identifying unit, wherein

the image preprocessing unit is configured to preprocess a plurality of images of known types, wherein the preprocessing at least includes data augmentation;

the image identification training unit is configured to input the images preprocessed by the image preprocessing unit into a convolutional neural network to perform type identification training by use of an identification model, and optimize the identification model based on a type identification result and the known types;

the to-be-identified image acquiring unit is configured to acquire multiple images to be identified; and

the image identifying unit is configured to identify the multiple images to be identified acquired by the to-be-identified image acquiring unit by use of the optimized identification model in the convolutional neural network.

In some embodiments, the to-be-identified image acquiring unit may include: a key image frame extracting module, a key image frame determining module, an image decoding module and a to-be-identified image generating module, wherein

the key image frame extracting module is configured to extract a first number of key image frames from a video to be identified;

the key image frame determining module is configured to compare the first number with a set threshold to determine a second number of key image frames;

the image decoding module is configured to decode the second number of key image frames to generate a series of images; and

the to-be-identified image generating module configured to normalize the series of images to generate the multiple images to be identified.

In some embodiments, the data augmentation at least includes equal-angle rotation, and preferably, the equal angle is 45 degrees.

In some embodiments, the data augmentation further includes image luminance processing including:

acquiring a pixel gray value of each of a plurality of images;

determining a gray mean of the plurality of images based on the pixel gray value of each of the plurality of images; and

comparing each gray value with the gray mean, and if there is one gray value greater than the gray mean, generating an image copy with lower luminance for the image corresponding to said one gray value.

In some embodiments, the preprocessing further includes image mean reduction image by image.

In some embodiments, the key image frame extracting unit is configured to extract a plurality of image frames from a video to be identified and screen the first number of key image frames from the plurality of image frames.

In some embodiments, the key image frame determining unit is configured to:

determine the second number as the first number if the key image frame determining module determines that the first number is less than or equal to the set threshold; and

determine that the second number is one N-th of the first number if the key image frame determining module determines that the first number is greater than the set threshold to enable the second number to be less than or equal to the threshold, wherein N is an integer greater than or equal to 2.

In some embodiments, the normalizing may include image mean reduction image by image.

The above system or device may be a server or a server cluster, and all corresponding units may be related processing units in the server, or one or more servers in the server cluster. If the related units are one or more servers in the server cluster, the interaction among the units is that among the servers, which will not be restricted in the present disclosure.

As features of the video identification system and the video identification method according to the above embodiments correspond to one another, contents related to the video identification system and method will not be repeated herein. It could be understood that hardware processor can be used to implement relevant function module of embodiments of the present disclosure.

Further, the present disclosure also provides a non-transitory computer-readable storage medium. One or more programs including execution instructions are stored in the storage medium, and the execution instructions can be read and executable by electronic equipment with a control interface for executing related steps in the above method according to the embodiments. The steps include:

preprocessing a plurality of images of known types, wherein the preprocessing at least includes data augmentation;

inputting the plurality of preprocessed images into a convolutional neural network to perform type identification training by use of an identification model, and optimizing the identification model based on a type identification result and the known types;

acquiring multiple images to be identified; and

identifying the multiple images to be identified by use of the optimized identification model in the convolutional neural network.

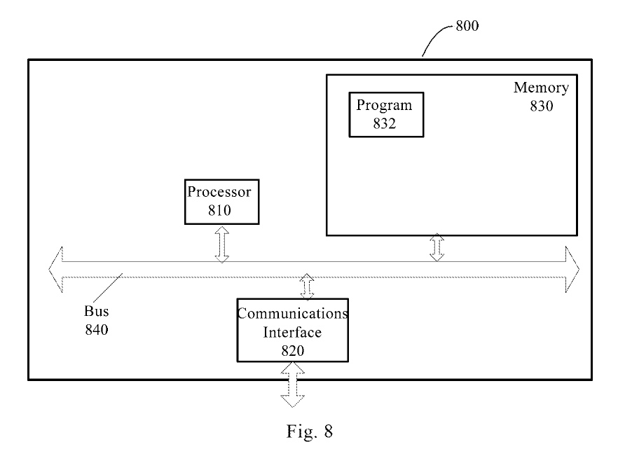

FIG. 8 shows a schematic drawing of user equipment 800 according the embodiments of the present application, and the specific embodiments of the present disclosure do not limit specific implementation of the user equipment 800. As shown in FIG. 8, the user equipment 800 may include: a processor 810, a communications interface 820, a memory 830 and a communication bus 840.

The processor 810, the communications interface 820 and the memory 830 are communicated with one another via the communication bus 840.

The communications interface 820 is configured to communicate with a network element, such as a client.

The processor 810 is configured to execute a program 832 in the memory 830, and specifically, can execute the related steps in the above method according to the embodiments.

Particularly, the program 832 may include a program code including a computer operation instruction.

The processor 810 may be a central processing unit (CPU), an ASIC (present application Specific Integrated Circuit), or one or more integrated circuits configured to implement the embodiments of the present application.

The memory 830 is configured to store the program 832. The memory 830 may include a high-speed RAM memory, and may also include a non-volatile memory, for example, at least one magnetic disk memory. The program 832 is specifically configured to enable the user equipment 400 to execute the following steps:

an image preprocessing step: preprocessing a plurality of images of known types, wherein the preprocessing at least includes data augmentation;

an image identification training step: inputting the preprocessed images into a convolutional neural network to perform type identification training by use of an identification model, and optimizing the identification model based on a type identification result and the known types;

a to-be-identified image acquiring step: acquiring multiple images to be identified; and

an image identifying step: identifying the multiple images to be identified by use of the optimized identification model in the convolutional neural network.

Specific implementation of each step in the program 832 can refer to corresponding description of corresponding steps and units in the above embodiments and are not repeated herein. It will be clearly understood by the skilled person in the art that specific operations of the device and modules mentioned above can be referred to the corresponding processes described in the foregoing embodiments of method of the present disclosure and hence are omitted for the sake of conciseness.

The present disclosure also provides a non-transitory computer-readable storage medium storing executable instructions for a video identification. The executable instructions, when executed by a processor, may cause the processor to: preprocess a plurality of images of known types to at least include data augmentation, input the plurality of preprocessed images into a convolutional neural network to perform type identification training by use of an identification model, and optimize the identification model based on a type identification result and the known types, acquire multiple images to be identified, and identify the multiple images to be identified by use of the optimized identification model in the convolutional neural network.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A video identification method, comprising:
preprocessing a plurality of images of known types, wherein the preprocessing at least comprises data augmentation;
inputting the plurality of preprocessed images into a convolutional neural network to perform type identification training by use of an identification model, and optimizing the identification model based on a type identification result and the known types;
acquiring multiple images to be identified; and
identifying the multiple images to be identified by the optimized identification model in the convolutional neural network.

2. The method of claim 1, wherein the data augmentation at least comprises equal-angle rotation.

3. The method of claim 2, wherein the equal angle is 45 degrees.

4. The method of claim 2, wherein the data augmentation further comprises image luminance processing which comprises:
acquiring a pixel gray value of each of the plurality of images;
determining a gray mean of the plurality of images based on the pixel gray value of each of the plurality of images; and
comparing each gray value with the gray mean, and if there is one gray value greater than the gray mean, generating an image copy with lower luminance for the image corresponding to the one gray value.

5. The method of claim 1, wherein the preprocessing further comprises image mean reduction image by image.

6. The method of claim 1, wherein acquiring multiple images to be identified comprises:
extracting a first number of key image frames from a video to be identified;
comparing the first number with a set threshold to determine a second number of key image frames;
decoding the second number of key image frames to generate a series of images; and
normalizing the series of images to generate the multiple images to be identified.

7. The method of claim 6, wherein extracting a first number of key image frames from a video to be identified comprises:
extracting a plurality of image frames from the video to be identified; and
screening the first number of key image frames from the plurality of image frames.

8. The method of claim 6, wherein comparing the first number with the set threshold to determine a second number of key image frames comprises:
determining the second number as the first number if the first number is less than or equal to the set threshold; and
determining that the second number is one N-th of the first number if the first number is greater than the set threshold to enable the second number to be less than or equal to the threshold, wherein N is an integer greater than or equal to 2.

9. The method of claim 6, wherein the normalizing process comprises image mean reduction image by image.

10. An electronic device for video identification, comprising:
at least one processor; and
a memory communicably connected with the at least one processor for storing instructions executable by the at least one processor, wherein execution of the instructions by the at least one processor causes the at least one processor to:
preprocess a plurality of images of known types, wherein the preprocessing at least comprises data augmentation;
input the preprocessed images into a convolutional neural network to perform type identification training by use of an identification model, and optimize the identification model based on a type identification result and the known types;
acquire multiple images to be identified; and
identify the multiple images to be identified by use of the optimized identification model in the convolutional neural network.

11. The electronic device of claim 10, wherein the data augmentation at least comprises equal-angle rotation.

12. The electronic device of claim 11, wherein the equal angle is 45 degrees.

13. The electronic device of claim 11, wherein the data augmentation comprises image luminance processing performed by:
acquiring a pixel gray value of each of the plurality of images;
determining a gray mean of the plurality of images based on the pixel gray value of each of the plurality of images; and
comparing each gray value with the gray mean, and if there is one gray value greater than the gray mean, generating an image copy with lower luminance for the image corresponding to said one gray value.

14. The electronic device of claim 10, wherein the instructions to cause the at least one processor to preprocess the plurality of images of the known types further cause the at least one process to reduce image mean image by image.

15. The electronic device of claim 10, wherein the instructions to cause the at least one processor to acquire the multiple images to be identified further cause the at least one processor to:
extract a first number of key image frames from a video to be identified;
compare the first number with a set threshold to determine a second number of key image frames;
decode the second number of key image frames to generate a series of images; and
normalize the series of images to generate the multiple images to be identified.

16. The electronic device of claim 15, wherein the instructions to cause the at least one processor to extract the first number of the key image frames further cause the at least one processor to:
extract a plurality of image frames from a video to be identified; and
screen the first number of key image frames from the plurality of image frames.

17. The electronic device of claim 15, wherein the instructions to cause the at least one processor to compare the first number with the set threshold further cause the at least one processor to:
determine the second number as the first number if the key image frame determining module determines that the first number is less than or equal to the set threshold; and
determine that the second number is one N-th of the first number if the key image frame determining module determines that the first number is greater than the set threshold to enable the second number to be less than or equal to the threshold, wherein N is an integer greater than or equal to 2.

18. The electronic device of claim 15, wherein the instructions to cause the at least one processor to normalize the series of images further cause the at least one processor to: normalize comprises image mean reduction image by image.

19. A non-transitory computer-readable storage medium storing executable instructions for a video identification, wherein the executable instructions, when executed by a processor, cause the processor to:
preprocess a plurality of images of known types to at least comprise data augmentation;
input the plurality of preprocessed images into a convolutional neural network to perform type identification training by use of an identification model, and optimize the identification model based on a type identification result and the known types;
acquire multiple images to be identified; and
identify the multiple images to be identified by the optimized identification model in the convolutional neural network.

20. The non-transitory computer-readable storage medium of claim 19, wherein the executable instructions, when executed by the processor, cause the processor to acquire multiple images to be identified, further cause the processor to:
extract a first number of key image frames from a video to be identified;
compare the first number with a set threshold to determine a second number of key image frames;
decode the second number of key image frames to generate a series of images; and
normalize the series of images to generate the multiple images to be identified.
